(19) United States
(12) Patent Application Publication
(10) Pub. No.: US 2004/0184355 A1
(43) Pub. Date: Sep. 23, 2004

(54) Timepiece

(76) Inventor: Peter M. Simonson, Miami Beach, FL (US)

Correspondence Address: Gregory A. Nelson, Akerman Senterfitt, 222 Lakeview Avenue, Fourth Floor, P.O. Box 3188, West Palm Beach, FL, 33402-3188, US

(21) Appl. No.: 10/394,642

(22) Filed: Mar. 21, 2003

(51) Int. Cl. G04B 19/24

(52) U.S. Cl. 368/28

(57) ABSTRACT

A timepiece includes an indicator for indicating the passage of one hundred years, and preferably in one year increments. The indicator can be a year hand which revolves, each revolution indicating the passage of one hundred years. The indicator can be set to provide an indication of the age of the owner, the number of years since activation of the timepiece, or some other period relevant to the user. The timepiece can be a watch.

### STATEMENT REGARDING FEDERALLY SPONSORED RESEARCH OR DEVELOPMENT

Not applicable.

### FIELD OF THE INVENTION

This invention relates generally to timepieces, including watches and clocks.

### BACKGROUND OF THE INVENTION

Timepieces, such as watches and clocks, frequently have dials bearing moving pointers or hands for indicating different aspects of time, such as seconds, minutes, hours, weeks, and months. These hands can rotate about a common point of rotation, usually the center of the dial, or about several different points of rotation located at different positions on the dial. Although such timepieces generally provide adequate information for every day use, additional information is sometimes desirable.

### SUMMARY OF THE INVENTION

The invention relates to a timepiece having an indicator for indicating up to one hundred years of time. The indicator can include any suitable display and mechanism, such as mechanical and electronic. The indicator preferably includes a moving year hand indicating the year. The year hand preferably rotates 360° about a point of revolution, where each such revolution indicates the passage of one hundred years. Markings on the face or other portion of the timepiece indicate the year according to the position pointed to by the year hand. The complete revolution about the point of revolution can indicate any number of years according to the mechanism of the timepiece and the markings on the dial; however, one hundred years per revolution is preferred. The year hand can revolve about a point of revolution common to one or more of the second, minute, and hour hands of the timepiece, or can be provided separately on the timepiece.

### BRIEF DESCRIPTION OF THE DRAWINGS

There are shown in the drawings embodiments which are presently preferred, it being understood, however, that the invention is not limited to the precise arrangements and instrumentalities shown, wherein:

FIG. 1 is a front elevation of a timepiece according to the invention.

FIG. 2 is a front elevation of a timepiece according to an alternative embodiment.

### DETAILED DESCRIPTION OF THE PREFERRED EMBODIMENTS

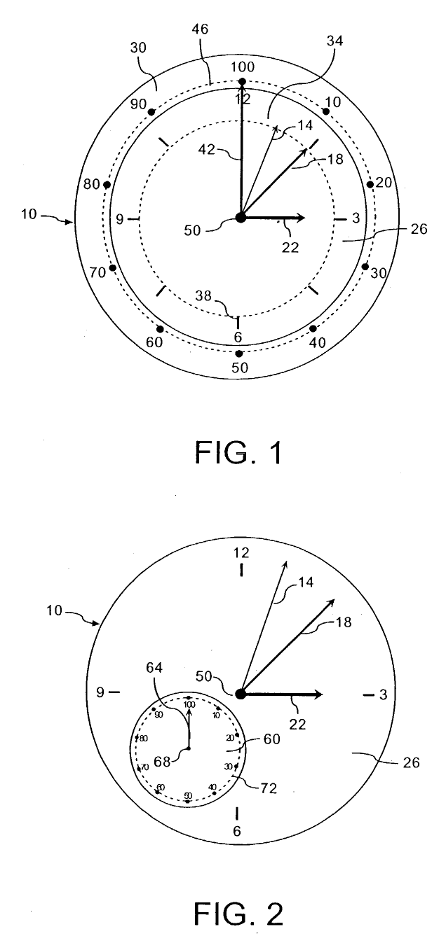

There is shown in FIG. 1 a timepiece 10. The timepiece 10 can be a watch, clock, or other suitable construction for a timepiece. In a preferred embodiment, the timepiece 10 is a watch. The watch can have indicators or hands for identifying appropriate aspects of the current time. The indicators can have any suitable mechanism and display for keeping and displaying the time, including electronic or mechanical. As is known, a second hand 14 can be provided to indicate seconds, a minute hand 18 can be provided to indicate minutes, and an hour hand 22 can be provided to indicate hours. Suitable corresponding markings on the face 26 or surrounding portion of the timepiece, such as bezel 30, can include appropriate markings from which the user can discern the appropriate time. Accordingly, markings 34 can be provided to indicate minutes and seconds, and markings 38 can indicate hours.

According to the invention, an indicator is provided for indicating the passage of years up to one hundred years. The indicator includes a mechanism and display, which can be mechanical, electronic, or any other suitable mechanism and display. In one aspect, a year hand 42 can be provided to indicate the year. Markings 46 are provided to indicate with the year hand 42 the appropriate year. The markings 46 can indicate the passage of a year, or increments of years such as five years. One hundred markings can be circumferentially disposed on the face of the timepiece such that one revolution of the year hand indicates the passage of one hundred years, in one year increments. In this embodiment, the marks 46 are indicated such that one revolution around the dial will indicate the passage of up to one hundred years. It will be appreciated, however, that with appropriate mechanisms and markings, any number of years can be delineated by one revolution of the year hand 42. In one aspect, the year hand 42 can indicate the age of the timepiece or of the owner, as the indicator can be initialized to 0 upon operation of the timepiece or set to the current age of the owner.

The mechanism for moving the year hand 42 in order to indicate passing years can be any suitable mechanism. Timepiece mechanisms for indicating second, minute, hour, day of the week, and month are known.

According to some timepiece constructions, all hands revolve around a common point of revolution. The second hand 14, minute hand 18, hour hand 22, and year hand 42 revolve around a point 50 of revolution. Other embodiments are possible.

There is shown in FIG. 2 an embodiment in which the year indicator 60 is shown as a separate dial on the face 26 of the timepiece 10. The year hand 64 rotates about a point of revolution 68 that is different from the point of revolution 50 of the second hand 14, minute hand 18, and hour hand 22. Appropriate markings 72 on the dial 60 indicate to the user the year according to the position of the year hand 64. Many other variations are possible for positioning the year hand relative to other hands on the timepiece face.

The invention can be utilized to provide an indication of any period of years that is relevant to the user. In one use, the indicator is used to indicate the age of the user. In another use, the indicator is used to indicate the period of years from initialization of the indicator. Other relevant periods are possible.

This invention can be embodied in other forms without departing from the spirit or essential attributes thereof and, accordingly, reference should be had to the following claims rather than to the foregoing specification as indicating the scope of the invention.

I claim:

1. A timepiece, comprising an indicator for indicating the passage of years up to one hundred years.

2. The timepiece of claim 1, wherein said indicator is a year hand which revolves, each revolution indicating a period of one hundred years.

3. The timepiece of claim 2, wherein said timepiece comprises markings such that the position of the year hand provides year data.

4. The timepiece of claim 1, wherein said timepiece is a watch.

5. The timepiece of claim 1, wherein said indicator comprises a year hand, and said timepiece comprises at least one selected from the group consisting of minute, hour, day and month hands.

6. The timepiece of claim 5, wherein said year hand, and said at least one hand selected from the group consisting of minute, hour, day and month hands, revolve around a common point of revolution.

7. The timepiece of claim 5, wherein said year hand revolves around a point of revolution different from that of said at least one hand selected from the group consisting of minute, hour, day and month hands.

8. The timepiece of claim 1, wherein said indicator can be set to provide an indication of a period of years relevant to the user.

9. The timepiece of claim 8, wherein said indicator is a year hand which revolves, each revolution indicating a period of one hundred years.

10. The timepiece of claim 9, wherein said timepiece is a watch.

11. A method for telling time, comprising the steps of:
providing a timepiece having an indicator for indicating the passage of years up to one hundred years;
setting said indicator to provide an indication of a period of years other than the calendar year.

12. The method of claim 11, wherein said period of years is the age of the owner.

13. The method of claim 11, wherein said period of years is the number of years since the initialization of the indicator.
